(19) United States
(12) Patent Application Publication
(10) Pub. No.: US 2005/0069472 A1
(43) Pub. Date: Mar. 31, 2005

(54) Chrome-based product in a hydrolyzed proteic compound and process for the making thereof

(76) Inventors: Manuela Cinzia Candido, Chiampo VI (IT); Massimo Neresini, Arzignano 80 Chiampo (IT)

Correspondence Address: Joseph Fischer;Beusse Browniee Wolter Mora & Marie, 390 North Orange Avenue, Suite 2500, Orlando, FL, 32801, US

(21) Appl. No.: 10/495,312

(22) PCT Filed: Nov. 12, 2002
(86) PCT No.: PCT/IB02/04729

(30) Foreign Application Priority Data
Nov. 12, 2001 (IT) RM2001A000671

(51) Int. Cl. C09B 67/00; C01G 37/00

(52) U.S. Cl. 423/55; 8/635

(57) ABSTRACT

Chrome-based product in a hydrolized proteic compound and process for the making thereof, comprising a step of solubilizing the protein-Chrome complex contained in tanning residues like e.g. the shavings and the trimmings, produced from tannage hide shaving and trimming steps, the fleshing, the limed pieces and the splittings, produced from pretanning processes, and the shaving sludges, allowing to effectively carry Chrome in the tanning processes and to recycle the Chrome contained in the wastes from tanning processes, directly making a product reusable in the latter.

The present invention relates to a Chrome-based product in a hydrolized proteic compound and to a process for the making thereof.

Chrome is an element commonly employed by the tanning industry for the treating of hides. This practice yields large quantities of wastes comprising Chrome-containing connective tissue offals, whose disposal should follow specific procedures in order to prevent Chrome discharges in the environment.

Among these wastes, by way of example shavings and trimmings may be mentioned, produced from tannage shaving and trimming steps, and fleshing, limed pieces and splittings, produced from pretanning processes, like e.g. liming. Moreover, also Chrome-containing shaving sludges fall within this category.

Various processes have been advanced for extracting Chromium from this type of waste in order to obtain industrially reusable Chromium, however their application is less than satisfactory due to their complexity and to the costs required to make a high-grade purified product.

Moreover, products derived from such wastes, based on the reaction between Chrome sulfate and hydrolized proteic compound obtained from raw materials containing connective tissue, like e.g. chemically hydrolized fleshing, limed pieces, splittings, shavings and trimmings, proved unsatisfactory at an industrial level, and in particular in tannage application, due to the offensive odor lingering on the finished hide.

In fact, the hydrolized proteic compounds obtained from the abovementioned collagenous material and then used in hide processing are easily fermentable, and hence unsuitable for manufacturing hides destined to clothing, upholstery and the like, contexts where a hide-emitted foul odor would of course be unacceptable. Odor-masking tests yielded unsatisfactory outcomes.

The technical problem underlying the present invention is to provide a Chrome-based product in a hydrolized proteic compound and a process for the making thereof allowing to overcome the drawbacks mentioned with reference to the known art.

In this field, preliminary tests conducted highlighted that products containing hydrolized proteic compounds having a low degree of hydrolysis and a relatively high molecular weight have a high affinity for Chrome and can effectively carry Chrome in tanning processes. The formation of Chrome-hydrolized proteic compounds complexes is highlighted by the coagulation of the mass of dissolved product.

The insight underlying the solution of this problem is that of using the shavings as a raw material already comprising a protein-Chrome complex generated and stabilized in the tanning step. Tanning technological tests conducted highlighted that the protein extracted from the shavings and/or the trimmings, which may be defined hydrolized collagen compound, has a very high affinity for hide.

This protein-Chrome complex is also present in residues yielded by the processing of the shavings and/or the trimmings, like e.g. the process sludges for the production of hydrolized proteic compounds. In this case, the protein-Chrome complex requires solubilization for a tannage use thereof, and the yielded protein is just the collagen protein having a high affinity for hide.

Hence, this problem is solved by a Chrome-based product in a hydrolized proteic compound, characterized in that said hydrolized proteic compounds result from the solubilization of the protein-Chrome complex contained in tanning residues like the shavings and the trimmings, produced from tannage hide shaving and trimming steps, the fleshing, the limed pieces and the splittings, produced from the pretanning processes, and the shaving sludges.

The main advantage of the product according to the present invention lies in its capability of effectively carrying Chrome in tanning processes.

The invention further relates to a process for the making of a Chrome-based product, comprising a step of solubilizing the protein-Chrome complex contained in tanning residues, like e.g. the shavings and the trimmings, produced from tannage hide shaving and trimming steps, the fleshing, the limed pieces and the splittings, produced from pretanning processes, and the Chrome-containing shaving sludges.

Lastly, the invention is aimed at the use of the product as abovespecified in tanning and/or retanning processes.

The further advantage provided by the process according to the invention lies in the recycling of the Chrome contained in the wastes from tanning processes, directly making a product reusable in the latter.

The present invention will hereinafter be described according to a preferred embodiment thereof, together with some preferred applications thereof, given by way of a non-limiting example and with reference to the following examples.

According to a first embodiment, the preparation of the product according to the invention substantially consists in the solubilization of the protein-Chrome complex present in Chrome-containing wastes from tanning or pretanning processes.

E.g., for the shavings and/or for the trimmings, the solubilization takes place by acid addition. In particular, small subsequent quantities of shavings and/or trimmings are added to a quantity of acid.

Preferably, this acid, in particular sulfuric acid, is prediluted with water in order to limit its aggressiveness. An exemplary water-acid ratio suggested for dilution is of 1:1. However, this dilution can be of a ratio indicatively ranging from 2:1 to 1:2, and it is understood that a different acid, e.g. hydrochloric acid, may be employed for the same purpose.

This mixture is heated to a temperature ranging from 50 to 100° C., preferably to 85° C. It respects a specific ratio between the dry matter contained in the shavings and in the trimmings, in short called dry matter shavings, and the acid, ratio preferably ranging from 5 to 14. It is understood that this ratio refers to undiluted acid; a dilution will lead to a proportional variation of said ratio.

The resulting mass is kept boiling for a determined time, i.e. of at least 15 min, preferably of 3 h, in order to allow solubilization. At the end of said solubilization, the resulting mixture can suitably be filtered to separate the undissolved material.

The boiling of the mass is not aimed at hydrolyzing the hide-contained protein, rather at solubilizing the Chrome-protein complex. Products having substantially different molecular weights exhibit analogous behaviors in tanning and retanning processes.

Finally, e.g. a liquid product having the following characteristics is obtained:

| | |
|---|---|
| Dry matter | 45-55% |
| N | 5-8% |
| Chrome oxide (Cr₂O₃) | 1.5-2.5% |
| Density | 1.20-1.28 kg/dm³ |
| pH | 0.0-4.5 |

Optionally, the end product may be treated with alkalis in order to amend or to buffer the pH to the desired value. Moreover, the end product may be added with Chrome sulfate or other Chrome-based salts, and/or with tanning or retanning natural or synthetic substances, and/or with hydrolized collagen compounds or with gels or other gelling products.

Moreover, the product may be used in liquid or solid form.

According to another embodiment, post-extraction of the proteic matter from shaving byproducts and/or trimmings, there can be made a product apt to be used in tanning and retanning. E.g., the filter panel obtained from the protein extraction process may be used for the production of hydrolized proteic compounds or of hydrolized collagen compounds.

In this case, the preparation of the product consists in the acid-mediated solubilization of the sludge-contained Chrome, and essentially in adding acid quantities, preferably prediluted as in the first example with water in a ratio ranging from 2:1 to 1:2, preferably of 1:1, until obtaining acid pH values preferably ranging from 0 to 4.5, in heating, preferably brought to the boil, and subsequently in keeping the mass boiling for a time indicatively ranging from 20 min to 3 h. At the end of this solubilization a filtering is carried out to separate the undissolved material. Optionally, the panel may be rinsed with acid water, in order to recover as much solubilized material as possible, and then concentrated after an optional pH amending.

The product may be used in a diluted or concentrated liquid form, as well as in a powder form.

Finally, e.g. a liquid product having the following characteristics is obtained:

| | |
|---|---|
| Dry matter | 45-55% |
| N | 5-8% |
| Chrome (Cr₂O₃) | 4-6% |
| Density | 1.20-1.28 kg/dm³ |
| pH | 0.0-4.5 |

Using this type of products in retanning, leathers were obtained having a very good dyeing yield and good fullness, as well as a firm and fine grain. The retanning baths containing these products can be subjected to pH raises up to very alkaline values without ever exhibiting flocculation problems, thereby avoiding several problems related to an uneven Chrome distribution. This characteristic makes said products suitable also for the use in retanning systems not allowing appropriately frequent bath replacements. The hides tanned with these types of products have a flesh side that is highly compact and not very spongy. Rinsing tests for Chrome release to acid sweat of retanned hides yielded extremely low values.

Tanning tests conducted with some of the products disclosed in this patent application yielded positive results, like a good shrinkage temperature (e.g., of 74° C.). The shrinkage temperature characterizing the tanning agent type approaches the one obtained with tannins.

This result, together with the good results yielded in terms of Chrome release to acid sweat, may broaden the range of viable uses of these types of products to ecological tanning, which foresees utilization of alternative tanning materials yielding technologically good results and with very low releases of Chrome, formaldehyde and phenol contained in several products of common employ.

For the preparation of the products subject-matter of this patent, there are used shavings and/or trimmings which would be processed in an alternative way, and shaving sludges destined to dump disposal entailing remarkable economical and environmental problems. However, usually this type of waste is also subjected to administrative monitoring to check the correctness of the disposal thereof.

The products subject-matter of this invention lend themselves to being mixed to already marketed products, like e.g. Chrome sulfate with a basicity ranging from 25 to 50%, synthetic tannins and reduced organic and inorganic Chrome yielded by industrial processing residues of synthetic, organic, or natural origin products, e.g. obtained from sugar processing, improving the quality of the finished hides.

The products subject-matter of this invention may be dried up, obtaining a powder preparation.

The products subject-matter of this invention lend themselves to additions of other products utilized to decrease Chrome reactivity in tanning employ or to increase stability over time, and to be utilized in liquid as well as in solid form.

### PREPARATION EXAMPLES

### Example 1

To 200 g 50% w/w sulfuric acid heated to a temperature of 85° C. were subsequently added in small quantities 1756 g shavings, with average analysis: 45% w/w dry matter, 2.33% w/w Chrome (expressed as Cr₂O₃), 7.2% w/w total Nitrogen, until bringing the pH to values ranging from 1 to 2, under slow stirring and carrying on the heating. At the end of the shavings addition the mass was heated and left to boil for 3 hours, still under slow stirring. Then the solution was let cool down, always under slow stirring. The product was left to sediment at room temperature for several days, and finally the product was transferred to another vessel in order to eliminate the undissolved material deposited at the bottom. A product was obtained having the following analysis:

| | |
|---|---|
| Dry matter | 54% |
| Total Nitrogen | 6.1% |
| Chrome | 1.3% |
| pH | 1.8 |

### Example 2

To 1000 g filtration panel obtained from shavings and trimmings processing, having average analysis: 26% w/w dry matter, 1.6% w/w total Nitrogen, 1.70% w/w Chrome, 220 g 50% w/w sulfuric acid were slowly added, until bringing the pH to values ranging from 1 to 2, under slow stirring and heating up the mass to the boil. After a 60 min boiling the resulting mixture was filtered.

A product having the following analysis is obtained:

| | |
|---|---|
| Dry matter | 15% |
| Total Nitrogen | 2.4% |
| Chrome | 1.5% |
| pH | 1.8 |

### Example 3

To 1305 g filtration panel obtained from shavings and trimmings processing, having average analysis: 26% w/w dry matter, 1.6% w/w total Nitrogen, 1.70% w/w Chrome, 357 g 50% w/w sulfuric acid were slowly added, until bringing the pH to values ranging from 1 to 2, under slow stirring and heating up the mass to the boil. After a 20 min boiling the resulting mixture was filtered, then stirred 10 min and mixed to 250 g HCl-acidified water and brought to 90° C., with a subsequent further filtering. The rinsing step was repeated with the residual panel, and a further filtering was carried out.

Finally, 443 g wet panel having 48% w/w dry matter and 2065 g solution were obtained. The latter was subjected to concentration, obtaining 358 g product having the following analysis:

| | |
|---|---|
| Dry matter | 45.6% |
| Total Nitrogen | 3.6% |
| Chrome | 4.2% |
| pH | 1.9 |

Finally, 33 g 30% w/w soda were added to bring the product pH to 3.8:

### APPLICATION EXAMPLES

### Example 1

To 100 g tanned hide, shaved to a 1.1 mm thickness, 200% water at 40° C., 0.3% detergent and 0.5% acetic acid were added in order to cleanse and soak the hide, and to adjust the pH thereof. After a 30 min tumbling the bath was drained.

The subsequent retanning step was carried out utilizing 5% product obtained in example 1. In order to neutralize the hide, after a 60 min tumbling and without bath change 2% sodium formate, and after 30 min 2% sodium bicarbonate were added.

Upon draining the retanning/neutralizing bath, the processing was carried on inletting 200% water at 50° C. and 10% sulfited fatliquor into the test mini-drum; after 60 min 1% dye and after 30 min 1% formic acid were added.

Analyses carried out highlighted that in the initial retanning bath 688 mg/l Chrome were present, dropped to 230 mg/l at the end of neutralization. This data allows to trace back the product quantity fixated on the hide during the retanning step.

5g hide thus retanned rinsed with 100 g distilled water yield by release a Chrome concentration equal to 127 mg/kg. This value is in line with those obtained with other tanning or retanning agents commonly employed in tannage.

### Example 2

To 100 g pickled hide 100 g of the related pickling bath having pH 2.54 were added. The product obtained in Example 1 was added in a quantity equal to 15% w/w on the pickled weight. A slow-solubilizing alkalizing product containing 1.6% Magnesium oxide was added.

At +60, 90, 270, 360, 420, 480 min of mini-drum tumbling, the bath was sampled for testing the pH values. The latter were of 1,87, 2,85, 3,6, 3,8, 4,08, 4,20, respectively. At +8 h of mini-drum tumbling a further sampling was conducted for testing the end concentration of Chrome.

The tanning bath temperature was initially of 20° C., and it gradually rose to 36° C.

Analyses conducted on the tanning baths highlighted that about half of the released Chrome actually fixated on the hide, implementing a 0.73% Cr₂O₃ content on the dry hide which is far from the classical Chrome tanning standards envisaging >3.5% Cr₂O₃ values. However, the shrinkage temperature related to the hide thus treated is of 74° C., comparable to that obtained with tannins. The COD and TKN values are comparable to the initial ones.

### Example 3

To 100 g pickled hide 100 g of the related pickling bath having pH 2.54 were added. A product made of 80% organic Chrome with 12% w/w Cr₂O₃ titer and of 20% product made according to the process disclosed in Example 1 was added, in a quantity equal to 15% w/w of the pickled weight. A slow-solubilizing alkalizing product, containing 1.1% Magnesium oxide was added.

At +60, 90, 270, 360, 420, 480 min of mini-drum tumbling, the bath was sampled for testing the pH values. The latter were of 2, 15, 3, 32, 3, 80, 3,86, 4, 11, 4, 06, respectively.

At +8 h of mini-drum tumbling, a further sampling was carried out for testing the end concentration of Chrome.

The tanning bath temperature was initially of 20° C., and it gradually rose to 36° C.

Analyses conducted on tanning baths highlighted that more than half of the released Chrome actually fixated on the hide, implementing a 4.27% Cr₂O₃ content on the dry hide, with a >100° C. shrinkage temperature related to the hide thus treated.

The tanning technique application tests conducted on the products made with these processes highlight that the products subject-matter of this invention are successfully employable in this field.

The contained Chrome fixates effectively and evenly: the Chrome exhaustion in retanning baths is very good, and, as demonstrated by release tests, the hide-released Chrome quantities are very low.

Surface effects as the enhanced dyeing yield and the provision of ‘brightness’ are highlighted. Highly compact flesh sides, and a very limited flesh side/grain side color difference, a positive factor for high-grade products, are obtained.

Hides having good characteristics of fullness and softness as well as a good tactile yield are obtained.

The products made according to said processes may be utilized as tanning agents and/or as related auxiliary, retanning, and fixing agents, hence on already stabilized hides.

The COD values in the retanning baths keep within acceptable value ranges, since the protein contained in the products subject-matter of the present invention have a very high affinity for leather and fixates effectively.

The products made according to the described processes may be used as tanning agents, yielding hides having a good shrinkage temperature and yet a low Chrome content. The COD of the tanning bath waters remains high, as in this case the Chrome-bonded hydrolized collagen acts as carrier, and, due to the affinity for hide of these molecules, a pH value corresponding to the isoelectric point ranging from 4.5 to 6.5 is required. Optimum pHs for retanning range from 4.5 to 5.0.

Optional mixing to already marketed products, like e.g. Chrome sulfate having a 25-50% basicity, synthetic tannins, reduced inorganic and organic Chrome obtained from industrial processing residues of synthetic or natural origin products, e.g. obtained from sugar processing, entail tanning improvements like e.g. the improved dyeing brightness, and yield a more effective Chrome fixation along with a more favorable shrinkage temperature.

Optional additions of ‘masking’ products, like e.g., phthalates, citrates may be carried out in order to decrease Chromium reactivity and affinity in several specific tanning applications or to avoid product precipitation and coagulation phenomena over time. As hereto specified, addition of alkali maybe provided.

The cited products may be utilized and marketed in liquid as well as in solid form, e.g. in powder.

To the abovedescribed Chrome-based product and related process for the making thereof a person skilled in the art, in order to satisfy further and contingent needs, may effect several further modifications and variants, all however falling within the protective scope of the present invention, as defined by the appended claims.

1. A Chrome-based product in a hydrolized proteic compound, wherein the hydrolyzed proteic compound results from the solubilization of a protein-Chrome complex contained in tanning residues as shavings and trimmings, produced from tannage hide shaving and trimming steps, fleshing, limed pieces and splittings, produced from pretanning processes, and shaving sludges.

2. The Chrome-based product according to claim 1, wherein said solubilization takes place by acid addition.

3. The Chrome-based product according to claim 2, wherein said solubilization is carried out by adding small subsequent quantities of shavings and/or trimmings to a quantity of sulfuric acid, prediluted with water and heated to a temperature ranging from 50 to 100° C.

4. The Chrome-based product according to claim 3, wherein the water-acid dilution ratio ranges from 2:1 to 1:2.

5. The Chrome-based product according to claim 4, wherein the water-acid dilution ratio is of 1:1.

6. The Chrome-based product according to claim 3, wherein said heating takes place at a temperature of about 85° C.

7. The Chrome-based product according to claim 3, wherein the dry matter shavings/acid ratio ranges from 5 to 14.

8. The Chrome-based product according to claim 3, wherein the mixture of trimmings and/or shavings and of acid is kept boiling for a >15 min time.

9. The Chrome-based product according to claim 1, in liquid form having the following characteristics:

| | |
|---|---|
| Dry matter | 45-55% |
| N | 5-8% |
| Chrome oxide (Cr₂O₃) | 1.5-6.0% |
| Density | 1.20 to 1.28 kg/dm³ |
| pH | 0.0 to 4.5 |

10. The Chrome-based product according to claim 1, provided in a powder preparation.

11. A process for the making of a Chrome-based product comprising a step of solubilizing a protein-Chrome complex contained in tanning residues as shavings and trimmings, produced from tannage hide shaving and trimming steps, fleshing, limed pieces and splittings, produced from pretanning processes, and Chrome-containing shaving sludges.

12. The process for the making of a Chrome-based product according to claim 11, wherein said solubilization takes place by acid addition.

13. The process for the making of a Chrome-based product according to claim 12, wherein said solubilization is carried out by adding small subsequent quantities of shavings and/or trimmings to a quantity of sulfuric acid, prediluted with water heated to a temperature ranging from 50 to 100° C.

14. The process for the making of a Chrome-based product according to claim 13, wherein the water-acid dilution ratio ranges from 2:1 to 1:2.

15. The process for the making of a Chrome-based product according to claim 14, wherein the water-acid dilution ratio is of 1:1.

16. The process for the making of a Chrome-based product according to claim 13, wherein said heating takes place at a temperature of about 85° C.

17. The process for the making of a Chrome-based product according to claim 13, wherein the dry matter shavings/acid ratio ranges from 5 to 14.

18. The process for the making of a Chrome-based product according to claim 13, wherein the mixture of trimmings and/or shavings and acid is kept boiling for more than 15 minutes.

19. The process for the making of a Chrome-based product according to claim 12, having in liquid form the following characteristics:

| | |
|---|---|
| Dry matter | 45-55% |
| N | 5-8% |
| Chrome oxide (Cr₂O₃) | 1.5-6.0% |
| Density | 1.20-1.28 kg/dm³ |
| pH | 0.0-4.5 |

20. The process for the making of a Chrome-based product according to claim 11, providing a step of mixing to Chrome sulfate having a 25-50% basicity, synthetic tannins, reduced inorganic and organic Chrome obtained from industrial processing residues of synthetic, organic, or natural origin.

21. The process for the making of a Chrome-based product according to claim 11, providing a step of mixing to masking products.

22. The process for the making of a Chrome-based product according to claim 21, wherein said masking products are selected from a group comprising phthalates, citrates and mixtures thereof.

23. The process for the making of a Chrome-based product according to claim 11, wherein an addition of alkali is provided.

24. Tanning agent comprising a Chrome-based product according to claim 1.

25. Fixing agent comprising a Chrome-based product according to claim 1.
